(19) United States
(12) Patent Application Publication
(10) Pub. No.: US 2026/0261582 A1
(43) Pub. Date: Sep. 3, 2026

(54) DEVICE AND METHOD FOR CONTEXT-AWARE DETECTION OF SENSOR SPOOFING ATTACKS

(71) Applicant: KOREA UNIVERSITY RESEARCH AND BUSINESS FOUNDATION, Seoul (KR)

(72) Inventors: Wonsuk CHOI, Seoul (KR); Dong Hoon LEE, Seoul (KR); Hyunsu CHO, Seoul (KR)

(21) Appl. No.: 19/532,660

(22) Filed: Feb. 6, 2026

(30) Foreign Application Priority Data
Feb. 19, 2025 (KR) 10-2025-0021333
Mar. 26, 2025 (KR) 10-2025-0038761

(51) Int. Cl. H04L 9/40

(52) U.S. Cl. CPC H04L 63/1483

(57) ABSTRACT

An apparatus and method for context-based sensor spoofing attack detection are disclosed. According to an embodiment, a method for detecting a sensor spoofing attack targeting a sensor of an autonomous system is performed by a computing device. The method includes: estimating an environmental state based on a system state, sensor measurements, and a control input for controlling an actuator included in the autonomous system; performing a first attack detection of detecting an attack based on a difference between a first sensor measurement and a second sensor measurement; performing a second attack detection of detecting an attack based on a difference between the estimated environmental state and a predicted environmental state calculated based on the control input; and performing a third attack detection of detecting an attack based on a probability that the sensor measurements fall within a normal range.

### CROSS-REFERENCE TO RELATED APPLICATION(S)

This application claims the benefit under 35 USC § 119 (a) of Korean Patent Application No. 10-2025-0021333 filed on Feb. 19, 2025, and Korean Patent Application No. 10-2025-0038761 filed on Mar. 26, 2025, in the Korean Intellectual Property Office, the entire disclosures of which are incorporated herein by reference for all purposes.

### TECHNICAL FIELD

The present invention relates to a method for detecting sensor spoofing attacks targeting autonomous systems, and more particularly, to an apparatus and method for detecting abnormal states by analyzing the context between sensor data and system states, thereby ensuring the safety and reliability of autonomous systems.

### BACKGROUND OF THE INVENTION

Due to the rapid advancement of autonomous systems, machines have become capable of perceiving, deciding, and acting without human intervention. Autonomous systems include autonomous vehicles, drones, and automated industrial robots, and they rely heavily on sensors to navigate and interact with their environments. Sensors provide critical data such as position, speed, direction, and proximity, enabling autonomous systems to operate safely and efficiently in the real world.

However, as autonomous systems become increasingly prevalent, threats are also on the rise. Attacks targeting sensors are carried out in a manner where an attacker manipulates sensor inputs to disrupt the normal operation of the system. Unlike conventional cyberattacks, sensor attacks can be executed by altering the physical environment or by directly injecting false data into sensor streams. For example, an adversarial patch strategically placed on a road can cause a malfunction in a vehicle's lane-keeping system, and GPS spoofing can cause a drone to deviate from its originally planned flight path.

The consequences of such attacks are severe. Undetected sensor attacks can lead to erroneous decision-making, which may result in mission failure, collisions, or even fatal accidents. Therefore, there is a need for robust detection and recovery mechanisms capable of protecting autonomous systems from these threats. Current research focuses primarily on two aspects: the detection of sensor attacks and the recovery from their impacts. However, effective recovery depends on accurate and rapid detection. Given the real-time operational requirements of autonomous systems, the detection mechanism must be able to identify attacks swiftly, ideally before significant impacts occur.

However, achieving both real-time detection and a low false-positive rate presents a significant challenge. Autonomous systems operate in complex and dynamic environments, where normal variations in sensor data-caused by factors such as uneven terrain or changes in weather—can potentially be misinterpreted as attacks. This leads to false positives, which trigger unnecessary recovery processes. These recovery processes disrupt normal operations and degrade system efficiency by excluding legitimate sensor measurements and forcing the system into a recovery mode.

To further emphasize the impact of false positives on system performance, a series of experiments was conducted to evaluate the effects of false positive frequency on resource utilization, mission success rate, and overall system efficiency. The experimental results clearly demonstrated that a high false-positive rate significantly degrades system performance. In particular, when the false-positive rate was high, frequent and unnecessary recovery processes led to increased CPU and memory usage, a marked decrease in the mission success rate, and prolonged recovery times. These results highlight the negative impact of false positives on system performance and underscore the necessity for an advanced detection mechanism that can ensure rapid response while maintaining a low false-positive rate.

Considering these challenges, several key research questions are raised:
Impact of False Positives: How do false positives affect the overall performance and reliability of autonomous systems?
Distinguishing Faults from Attacks: What is the method for effectively distinguishing between normal faults and malicious attacks in sensor data to minimize false positives?

To address these questions, the present invention proposes a novel detection technique titled CASAD (Context-Aware Sensor Attack Detection in Autonomous Systems Using Actuator Control Messages). The primary contributions of the proposed method are as follows:
Context-Based Detection: By utilizing context information derived from actuator control messages, the method reflects the physical complexity of real-world environments, thereby enabling more accurate sensor attack detection.
Reduction of False Positives: By dynamically adjusting detection thresholds using context information, the method significantly reduces unnecessary false positives and improves system stability.
Enhanced Alarm Reliability and Recovery Integration: The high reliability of the alarms generated by this method allows for seamless integration with existing recovery techniques, effectively responding to sensor attacks while minimizing disruptions to normal operations.

The proposed contributions focus on improving detection accuracy, reducing false positives, and strengthening alarm reliability, all of which are essential for ensuring the stable operation of autonomous systems.

### DISCLOSURE

### Technical Problem

A technical objective to be achieved by the present invention is to provide an apparatus and method for detecting context-based sensor spoofing attacks.

### Technical Solution

According to an embodiment of the present invention, a method for detecting a sensor spoofing attack targeting a sensor of an autonomous system is performed by a computing device and includes the steps of: estimating an environmental state based on a system state, a sensor measurement, and a control input for controlling an actuator included in the autonomous system; a first attack detection step of detecting an attack based on a difference between a first sensor measurement and a second sensor measurement; a second attack detection step of predicting an environmental state based on the control input and detecting an attack based on a difference between the estimated environmental state and the predicted environmental state; and a third attack detection step of detecting an attack based on a probability that the sensor measurement falls within a normal range.

### Advantages Effects

The present invention can significantly improve the accuracy of spoofing attack detection by analyzing the context based on system states, external environmental conditions, and sensor data.

Furthermore, the present invention minimizes false positives and false negatives by utilizing the correlation between sensor data and control messages, and provides a robust defense mechanism against various attack scenarios.

In addition, the present invention is designed to enable real-time detection, thereby enhancing the safety and reliability of unmanned vehicles and autonomous systems, while operating effectively in diverse environments.

### BRIEF DESCRIPTION OF DRAWINGS

A detailed description of each drawing is provided to ensure a more thorough understanding of the drawings cited in the detailed description of the present invention.

FIG. 1 is a flowchart illustrating a method for detecting sensor spoofing attacks according to an embodiment of the present invention.

### DETAILED DESCRIPTION OF THE INVENTION

Disclosed hereinafter are exemplary embodiments of the present invention. Particular structural or functional descriptions provided for the embodiments hereafter are intended merely to describe embodiments according to the concept of the present invention. The embodiments are not limited as to a particular embodiment.

Various modifications and/or alterations may be made to the disclosure and the disclosure may include various example embodiments. Therefore, some example embodiments are illustrated as examples in the drawings and described in detailed description. However, they are merely intended for the purpose of describing the example embodiments described herein and may be implemented in various forms. Therefore, the example embodiments are not construed as limited to the disclosure and should be understood to include all changes, equivalents, and replacements within the idea and the technical scope of the disclosure.

Terms such as “first” and “second” may be used to describe various parts or elements, but the parts or elements should not be limited by the terms. The terms may be used to distinguish one element from another element. For instance, a first element may be designated as a second element, and vice versa, while not departing from the extent of rights according to the concepts of the present invention.

Unless otherwise clearly stated, when one element is described, for example, as being “connected” or “coupled” to another element, the elements should be construed as being directly or indirectly linked (i.e., there may be an intermediate element between the elements). Similar interpretation should apply to such relational terms as “between”, “neighboring,” and “adjacent to.”

Terms used herein are used to describe a particular exemplary embodiment and should not be intended to limit the present invention. Unless otherwise clearly stated, a singular term denotes and includes a plurality. Terms such as “including” and “having” also should not limit the present invention to the features, numbers, steps, operations, subparts and elements, and combinations thereof, as described; others may exist, be added or modified. Existence and addition as to one or more of features, numbers, steps, etc. should not be precluded.

Unless otherwise clearly stated, all of the terms used herein, including scientific or technical terms, have meanings which are ordinarily understood by a person skilled in the art. Terms, which are found and defined in an ordinary dictionary, should be interpreted in accordance with their usage in the art. Unless otherwise clearly defined herein, the terms are not interpreted in an ideal or overly formal manner.

Hereinafter, example embodiments will be described with reference to the accompanying drawings. However, the scope of the patent application is not limited to or restricted by such example embodiments. Like reference numerals used herein refer to like elements throughout.

Conventional sensor attack detection techniques primarily rely on threshold-based anomaly detection methods, which inherently allow for a certain level of False Positive Rate (FPR). These false positives unnecessarily activate the recovery mode of the system. Although the recovery mode is designed to handle physical sensor attacks, it does not completely recover the system from physical damage caused by the attacks. Instead, the primary objective of the recovery mode is to ensure that the system does not fail completely and to allow for continued operation for a short period while mitigating risks.

In autonomous systems, activating a recovery mode in response to a sensor attack is a critical safety measure. However, when false positives occur frequently due to the high FPR of conventional detection methods, the system unnecessarily enters the recovery mode even under normal conditions. This leads to the following negative consequences:
Unnecessary Performance Degradation: The system operates in a conservative and inefficient mode even though no actual attack has occurred.
Increased System Downtime: The recovery mode disrupts normal operations, thereby reducing efficiency and responsiveness.
Resource Consumption: Unnecessary activation of the recovery mode consumes computational and energy resources, reducing the overall efficiency of the system.

To more clearly understand the limitations of conventional methods, the false-positive rates reported in prior studies were analyzed, and their impact on autonomous system performance was investigated. The results of the research are as follows:
Many conventional techniques allow for a certain level of FPR, which is regarded as an inevitable cost for attack detection.
However, in real-world environments, frequent false positives trigger excessive activation of the recovery mode, which can seriously undermine system stability.
False positives occur frequently due to the absence of a method that can effectively distinguish between sensor faults (or sensor defects) and actual sensor attacks.

Considering the problems caused by a high false-positive rate, there is a need for a detection framework that satisfies the following requirements:
Minimize false positives while maintaining high detection accuracy.
Distinguish between sensor faults and actual attacks to prevent unnecessary activation of the recovery mode.
Ensure stability by reducing system disruptions caused by misclassification.

To meet these requirements, the present invention proposes CASAD (Context-Aware Sensor Attack Detection). CASAD integrates external environmental state estimation into the detection process. By utilizing additional context, CASAD can significantly reduce false positives while maintaining high attack detection performance.

### Feedback Control Loop of Autonomous Systems

At the core of an autonomous system lies a feedback control loop, which is a fundamental mechanism that allows the system to continuously adapt to its environment and maintain stable operation. The feedback loop operates by continuously collecting real-time information regarding the system's state, such as position, speed, and direction, from sensors. This sensor data is input into the system's controller, which processes the data to generate control commands for actuators. The actuators execute these commands to adjust the system's actions (e.g., steering or adjusting the speed of a vehicle). The results of these actuator actions are then measured again by the sensors. As this process repeats, the system can react to environmental changes in real-time.

This closed-loop mechanism is a key element that enables an autonomous system to maintain desired operational parameters, such as speed, direction, and stability. In particular, this mechanism is critical in systems where real-time adjustment is essential, such as autonomous vehicles or drones.

### Relationship Between Actuator Control Messages and Sensor Data

Within the feedback control loop, a critical relationship exists between actuator control messages and sensor data. Control messages sent to an actuator represent desired changes in the system's operation, which are generated based on current sensor measurements. For example, if a vehicle's speed sensor indicates an overspeed condition, the controller may transmit an actuator command to reduce accelerator pedal input or apply the brakes. Conversely, if the vehicle is moving too slowly, it may receive a command to increase acceleration.

This dynamic interaction between sensors and actuators creates a continuous exchange of information. Sensors provide data regarding the current state of the system, and actuators adjust the system according to desired state changes. However, if this relationship is disrupted due to external interference, system faults, or attacks, the system becomes unable to perform normal operations. This strong coupling is a strength of autonomous systems, but it simultaneously represents a vulnerability.

### Sensor Attack Detection Utilizing Actuator Control Messages

Considering the critical correlation between sensor data and actuator commands, the potential for detecting sensor attacks by utilizing actuator control messages becomes evident. The core concept is that, under normal conditions, sensor measurements should align with the expected system state indicated by the actuator commands. For example, if an actuator commands a vehicle to accelerate, the speed sensor should reflect a corresponding increase in speed.

However, if an attacker manipulates sensor data (e.g., reporting a false location through GPS spoofing or providing incorrect orientation through IMU spoofing), this relationship is disrupted. By comparing the expected system state derived from the actuator commands with the actual sensor measurements, discrepancies that may indicate the presence of an attack can be identified. This approach enables a context-aware detection mechanism, wherein the system can dynamically adjust expectations based on control messages, thereby improving detection accuracy while reducing false positives.

Using actuator control messages as a baseline for expected behavior provides a robust foundation for identifying sensor attacks. Since the intended actions of the system are represented by actuator commands, any unexpected deviations that cannot be physically explained can be suspected as an attack, allowing for more effective detection of sensor spoofing or manipulation attacks.

### Physical Attacks in Autonomous Systems

Physical attacks targeting autonomous systems are becoming an increasingly significant threat, as attackers can distort sensor values by manipulating the physical environment without direct access to the system. Such attacks include GPS spoofing, which induces a vehicle to move along an incorrect path using forged (or fake) GPS signals, and adversarial patches, which disrupt computer vision systems by modifying images perceived by a camera. Another example is IMU spoofing, which manipulates gyroscopes and accelerometers to induce the system to interpret erroneous movements or orientations.

These attacks can be executed relatively easily without specialized equipment. Attackers can manipulate the physical environment in ways that are difficult to detect using conventional cybersecurity techniques. For instance, attaching an adversarial patch to a road sign can deceive the camera system of an autonomous vehicle, leading to incorrect lane positioning or collisions. Similarly, GPS spoofing can cause a drone to deviate from its intended path, potentially leading to mission failure or the loss of the vehicle or drone.

The most significant problem with these physical attacks is their ability to bypass conventional digital security mechanisms. Since the attacks exploit the physical layer of the system, detection requires an understanding of the physical environment in which the autonomous system operates. By comparing the expected system state derived from actuator control messages with real-time sensor data, anomalies indicating sensor manipulation can be detected, providing a novel defense strategy.

In the present invention, it is assumed that the primary threat is a physical attack in which a malicious attacker manipulates sensor measurements. The objective of the attacker is to tamper with sensor data so that it fails to accurately reflect the actual state of the system. If the tampered sensor data remains undetected, it is passed to the system controller, which then processes the inaccurate information to generate incorrect control commands. Consequently, the autonomous system may operate in an unexpected or dangerous manner.

It is assumed that the attacker is not limited to a specific sensor but can manipulate multiple sensors simultaneously. However, it is further assumed that the attacker cannot directly intervene in system components other than the sensors, such as actuators or controllers. That is, the core components of the system are securely protected, and the attacker cannot physically manipulate them.

Furthermore, it is assumed that the attacker has no prior knowledge of the detection techniques implemented within the system. In other words, since the attacker does not know how the detection framework operates or responds to detection, the attack is performed in a blind state.

Finally, it is assumed that under normal conditions, the sensors meet performance guarantees. That is, in the absence of an attack, the sensors will provide accurate and reliable data, and any significant deviation from this normal operation can be interpreted as a high likelihood of malicious intervention.

### Hereinafter, the Proposed CASAD Framework Will be Described.

Autonomous systems utilize various sensors such as LiDAR, cameras, GPS, and IMUs to perceive their surroundings and make control decisions. However, sensor spoofing attacks can manipulate these data sources to induce incorrect decisions and threaten system safety. Conventional sensor anomaly detection techniques primarily focus on analyzing inconsistencies within sensor data and do not sufficiently consider external environmental factors. To overcome these limitations, the present invention proposes a Context-Aware Sensor Attack Detection (CASAD) framework. CASAD merges external environmental factors into the attack detection process.

CASAD models the environmental state yₜ as a critical parameter for determining the consistency of sensor observations. By utilizing temporal-spatial consistency across multiple sensors and CUSUM-based detection for GPS and IMUs, CASAD effectively detects spoofing attacks targeting LiDAR, cameras, IMUs, and GPS. The framework is designed to distinguish between normal environmental changes and malicious sensor manipulation, thereby improving the reliability and safety of autonomous systems.

CASAD consists of the following three primary components:
1) Environmental State Estimation: Estimates external environmental parameters that affect sensor data.
2) Temporal-Spatial Consistency Evaluation: Evaluates the consistency of multi-sensor data across time and heterogeneous modalities.
3) Attack Detection Mechanism: Identifies sensor spoofing attacks based on statistical anomaly detection.

### 1. Environmental State Estimation

The environmental state yₜ represents key external factors that influence the perception of the autonomous system. Unlike the internal system state xₜ, which describes the motion and dynamics of the autonomous system itself, yₜ focuses on the attributes of the external environment (e.g., object positions, road conditions, positions and velocities of obstacles, and meteorological factors such as illumination and wind speed).

Mathematically, yₜ is defined as follows:

$${y}_{t} = [ {y}_{pos , t} , {y}_{vel , t} , {y}_{size , t} , {y}_{road , t} , {y}_{weather , t} ] \qquad [ Equation 1 ]$$

Here, the meaning of each term is as follows:
y_{pos,t} is the estimated 3D position of a detected object at time t.
y_{vel,t} represents the velocity of the object at time t.
y_{size,t} represents the dimensions or size of the object at time t.
y_{road,t} represents the road conditions (e.g., friction coefficient, curvature) at time t.
y_{weather,t} includes external factors (e.g., lighting, wind conditions) at time t.

Since yₜ cannot be directly observed, it is estimated using sensor measurements and system dynamics. The estimation function is formulated as follows:

$${y}_{t} = g ( {x}_{t} , {z}_{t} , {u}_{t} ) \qquad [ Equation 2 ]$$

According to the above equation, the environmental state yₜ can be estimated by inputting the system state xₜ, the control input uₜ, and the sensor data zₜ into a predetermined estimation function g( ). Here, the estimation function may be predefined.

### 2. Temporal-Spatial Consistency Evaluation

CASAD evaluates the consistency of sensor data across time and heterogeneous sensor modalities.

Spatial Consistency Check. To evaluate spatial consistency, the positions of objects detected by LiDAR and the camera are compared. The Mahalanobis Distance may be used to measure the difference between the two object positions.

$${D}_{M}^{2} = {( {z}_{LiDAR , t} - {z}_{Camera , t} )}^{T} {\sum }^{- 1} ( {z}_{LiDAR , t} - {z}_{Camera , t} ) \qquad [ Equation 3 ]$$

Here, Σ is the covariance matrix of the sensor noise. A high

$${D}_{M}^{2}$$

value indicates a significant inconsistency, suggesting the possibility of a spoofing attack.

Temporal Consistency Check. A moving object must maintain a predictable trajectory. The predicted object state at time t is as follows:

$${\hat{y}}_{t} = f ( {y}_{t - 1} , {u}_{t} ) + {w}_{t} \qquad [ Equation 4 ]$$

Here, ŷₜ is the predicted object state, wₜ represents the process noise, and f(yₜ₋₁, uₜ) is a motion model. The motion model may be predefined.

The actual state (which may refer to the estimated state) and the predicted state are compared as follows:

$$‖ {\hat{y}}_{t} - {y}_{t} ‖ > τ \qquad [ Equation 5 ]$$

If the difference exceeds a threshold t, it may be determined as an anomaly.

CUSUM-based GPS and IMU Spoofing Detection. For the detection of GPS and IMU spoofing attacks, a Cumulative Sum (CUSUM) technique is used. This is effective for detecting small deviations over time. The CUSUM test statistics are calculated as follows:

$${S}_{t}^{+} = max ( 0 , {S}_{t - 1}^{+} + ( {z}_{t} - μ - k ) ) \qquad [ Equation 6 ]$$

$${S}_{t}^{-} = max ( 0 , {S}_{t - 1}^{-} - ( {z}_{t} - μ + k ) ) \qquad [ Equation 7 ]$$

Here,

$${S}_{t}^{+} , {S}_{t}^{-}$$

are the upper and lower CUSUM statistics, respectively; μ is the expected mean of the GPS/IMU data under normal conditions; k is a reference value for detecting shifts in the data.

The conditions under which an attack is detected are as follows:

$${S}_{t}^{+} > h or {S}_{t}^{-} > h \qquad [ Equation 8 ]$$

Here, h is a detection threshold. If either condition is met, it signifies that the GPS or IMU data has changed abnormally, which may be due to spoofing.

### 3. Attack Detection Mechanism

Based on consistency analysis and statistical monitoring, CASAD determines whether a sensor attack has occurred.

Anomaly Score Calculation. The probability that a sensor measurement aligns with normal system operation is calculated as follows:

$$P ( {z}_{t} \vert {x}_{t} , {y}_{t} ) = 1 - {F}_{{χ}_{k}^{2}} ( {D}_{M}^{2} ) \qquad [ Equation 9 ]$$

Here,

$${F}_{{χ}_{k}^{2}}$$

is the cumulative distribution function (CDF) of the Chi-squared distribution.

### Attack Type Classification.

Obstacle Insertion Attack: A case where an object is detected by LiDAR but not by the camera, or vice versa.
Obstacle Disappearance Attack: A case where an object detected in a previous frame suddenly disappears.
Velocity Manipulation Attack: A case where the estimated velocity of an object is inconsistent with expected motion patterns.
GPS/IMU Spoofing Attack: A case where the CUSUM statistics exceed a threshold, indicating an unexpected change in sensor data.

By integrating environmental state estimation, sensor consistency checks, and CUSUM-based GPS/IMU anomaly detection, CASAD provides a robust technique for detecting sensor spoofing attacks in autonomous systems.

### 4. Algorithm: CASAD Detection Process

To efficiently detect sensor spoofing attacks, a CASAD detection algorithm is defined that integrates environmental state estimation, temporal-spatial consistency checks, and statistical anomaly detection. The outline of the algorithm is as follows.

The proposed CASAD algorithm can detect sensor spoofing attacks in real-time by utilizing environmental state estimation and temporal-spatial consistency checks. By combining Mahalanobis distance analysis with motion modeling, the proposed framework robustly identifies sensor inconsistencies and classifies different types of attacks.

[Algorithm 1]
Algorithm 1 CASAD Sensor Attack Detection Algorithm

| Sensor measurements zₜ, system states xₜ, con- | |
|---|---|
| trol inputs uₜ Detection of sensor spoofing attack | |
| Step 1: Environmental State Estimation Estimate | |
| environmental state yₜ using: | |
| yₜ = g(xₜ, zₜ, uₜ) | (10) |
| Step 2: Spatial Consistency Check Compute Maha- | |
| lanobis Distance between LiDAR and camera obser- | |
| vations: | |
| ${D}_{M}^{2} = {( {z}_{LiDAR , t} - {z}_{Camera , t} )}^{T} {\sum }^{- 1} ( {z}_{LiDAR , t} - {z}_{Camera , t} )$ | (11) |
| $If {D}_{M}^{2} > {τ}_{s} , mark as potential attack . Step 3 :$ | |
| Temporal Consistency Check Predict the expected | |
| environmental state: | |
| ŷₜ = f(yₜ₋₁, uₜ) + wₜ | (12) |
| Compute deviation from the predicted state: | |
| δₜ = \|\|ŷₜ − yₜ\|\| | (13) |
| If δₜ > τₜ mark as potential attack: Step 4: Attack | |
| Decision Making Compute probability of sensor ob- | |
| servation being normal; | |
| $P ( {z}_{t} \vert {x}_{t} , {y}_{t} ) = 1 - {F}_{{χ}_{k}^{2}} ( {D}_{M}^{2} )$ | (14) |

If P(zₜ|xₜ, yₜ) < τ_{d}, classify as an attack. Step 5:
Attack Classification Object appears in LiDAR but
not in Camera or vice versa Classify as Obstacle In-
sertion Attack. Previously detected object disappears
suddenly Classify as: Obstacle Disappearance At-
tack. Velocity estimation deviates significantly Clas-
sify as Velocity Manipulation Attack. Step 6: Alert
and System Response Attack is detected Raise an
alarm and trigger countermeasures;

The proposed CASAD framework provides the following advantages. The adaptive sensitivity provided by the context score allows the detection mechanism to respond to the system's operational context, thereby reducing unnecessary false positives and improving accuracy. By considering the operational context, the system can respond resiliently to normal variations, enabling accurate attack detection without overreacting to legitimate changes. Furthermore, the framework is scalable and can incorporate additional contextual elements as needed, making it applicable to various autonomous systems.

For the efficient implementation of the CASAD framework, several factors must be considered, such as the appropriate selection of weights wᵢ for contextual factors and the development of an accurate system model for prediction ŷₜ. Calibration of the threshold parameters Tₘᵢₙ and Tₘₐₓ is also critical to maintain a balance between detection sensitivity and the false positive rate.

In systems equipped with multiple sensors, the CASAD framework calculates deviations for each sensor, and these deviations are aggregated to evaluate overall system integrity. By utilizing sensor fusion techniques, information from multiple sensors can be combined to improve detection accuracy, thereby enhancing detection reliability and system resilience.

The proposed dynamic approach for sensor attack detection offers the following key advantages.
Adaptability: By using contextual information, the system can dynamically adjust its sensitivity according to the current operating environment and system state. This reduces false positives and allows for more accurate detection of abnormal sensor behavior.
Generalizability: The proposed framework is applicable to various autonomous systems (e.g., vehicles, drones, and robots). It is designed to adapt to different contextual factors and allows for dynamic adjustment of thresholds based on system-specific requirements.
Real-time Performance: The CASAD framework is capable of processing data in real-time, making it suitable for time-sensitive applications where immediate detection and response are essential.

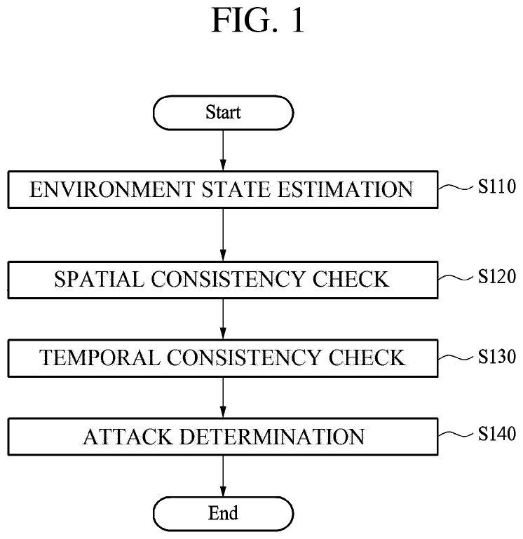

FIG. 1 is a flowchart illustrating an attack detection method according to an embodiment of the present invention.

Referring to FIG. 1, the attack detection method may be performed by a computing device including at least a processor or a controller, and/or a memory. In other words, at least some of the steps constituting the attack detection method may be understood as operations of a processor or a controller included in the computing device, in which case the computing device may be referred to as an attack detection apparatus. The computing device may include a personal computer (PC), a tablet PC, a laptop computer, a server, and the like. Additionally, the computing device may be implemented by a single device or by a plurality of devices to constitute a distributed environment.

Furthermore, the attack detection apparatus may be designed to be communicable with at least one of an autonomous system (such as an autonomous vehicle, a drone, an unmanned mobile vehicle, an autonomous robot, etc.) and/or components of the autonomous system (such as a sensor, a controller, a processor, etc.). According to an embodiment, the attack detection apparatus may be understood as a device provided in the autonomous system or as a part of the configuration of the autonomous system.

Hereinafter, in describing the attack detection method, detailed descriptions of contents that overlap with the previous descriptions will be omitted.

An environmental state is estimated (S110). The environmental state yₜ may be estimated using Equation 10 (Algorithm 1). The estimation function g(·) may be predefined or prepared and stored in the attack detection apparatus. Additionally, the system state xₜ, the control input uₜ, and the sensor data (sensor measurements) zₜ may be received from the autonomous system or may be pre-stored in the attack detection apparatus.

A spatial consistency check is performed (S120). The spatial consistency check involves deriving a difference between LiDAR measurements and camera measurements and determining the possibility of an attack based on the magnitude of the difference. In this case, the difference may be calculated using the Mahalanobis distance of Equation 11. If the calculated distance exceeds a first threshold, it may be determined as a (tentative) attack. If it is determined as a tentative attack, the following step may be performed.

A temporal consistency check is performed (S130). The temporal consistency check involves deriving a difference between a predicted environmental state and an estimated predicted state and determining the possibility of an attack based on the magnitude of the difference. In this case, the predicted environmental state may be calculated using Equation 12. If the difference calculated by Equation 13 exceeds a second threshold, it may be determined as a (tentative) attack. If it is determined as a tentative attack, the following step may be performed.

Whether an attack has occurred is determined (S140). To this end, a probability that the sensor measurement (sensor data) is normal is calculated. The probability may be calculated through Equation 14. In this case, if the calculated probability is smaller than a third threshold, it may be determined as a sensor spoofing attack.

The device described above can be implemented as hardware elements, software elements, and/or a combination of hardware elements and software elements. For example, the device and elements described with reference to the embodiments above can be implemented by using one or more general-purpose computer or designated computer, examples of which include a processor, a controller, an ALU (arithmetic logic unit), a digital signal processor, a microcomputer, an FPGA (field programmable gate array), a PLU (programmable logic unit), a microprocessor, and any other device capable of executing and responding to instructions. A processing device can be used to execute an operating system (OS) and one or more software applications that operate on the said operating system. Also, the processing device can access, store, manipulate, process, and generate data in response to the execution of software. Although there are instances in which the description refers to a single processing device for the sake of easier understanding, it should be obvious to the person having ordinary skill in the relevant field of art that the processing device can include a multiple number of processing elements and/or multiple types of processing elements. In certain examples, a processing device can include a multiple number of processors or a single processor and a controller. Other processing configurations are also possible, such as parallel processors and the like.

The software can include a computer program, code, instructions, or a combination of one or more of the above and can configure a processing device or instruct a processing device in an independent or collective manner. The software and/or data can be tangibly embodied permanently or temporarily as a certain type of machine, component, physical equipment, virtual equipment, computer storage medium or device, or a transmitted signal wave, to be interpreted by a processing device or to provide instructions or data to a processing device. The software can be distributed over a computer system that is connected via a network, to be stored or executed in a distributed manner. The software and data can be stored in one or more computer-readable recorded medium.

A method according to an embodiment of the invention can be implemented in the form of program instructions that may be performed using various computer means and can be recorded in a computer-readable medium. Such a computer-readable medium can include program instructions, data files, data structures, etc., alone or in combination. The program instructions recorded on the medium can be designed and configured specifically for the present invention or can be a type of medium known to and used by the skilled person in the field of computer software. Examples of a computer-readable medium may include magnetic media such as hard disks, floppy disks, magnetic tapes, etc., optical media such as CD-ROM's, DVD's, etc., magneto-optical media such as floptical disks, etc., and hardware devices such as ROM, RAM, flash memory, etc., specially designed to store and execute program instructions. Examples of the program instructions may include not only machine language codes produced by a compiler but also high-level language codes that can be executed by a computer through the use of an interpreter, etc. The hardware mentioned above can be made to operate as one or more software modules that perform the actions of the embodiments of the invention and vice versa.

Although the present invention is described with reference to the example embodiments illustrated in the drawings, it is provided as an example only and it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

1. A method for detecting a sensor spoofing attack targeting a sensor of an autonomous system, the method being performed by a computing device and comprising:
estimating an environmental state based on a system state, sensor measurements, and a control input for controlling an actuator included in the autonomous system;
performing a first attack detection of detecting an attack based on a difference between a first sensor measurement and a second sensor measurement;
predicting an environmental state based on the control input, and performing a second attack detection of detecting an attack based on a difference between the estimated environmental state and the predicted environmental state; and
performing a third attack detection of detecting an attack based on a probability that the sensor measurements fall within a normal range.

2. The method of claim 1,
wherein the estimating of the environmental state comprises estimating the environmental state (yₜ) using a first equation,
wherein the first equation is yₜ=g(xₜ, zₜ, uₜ),
and wherein the xₜ is the system state, the zₜ is the sensor measurements, the uₜ is the control input, and the g(·) is a predefined environmental state estimation function.

3. The method of claim 2,
wherein the first sensor measurement is a measurement of a LiDAR, and the second sensor measurement is a measurement of a camera,
and wherein the performing of the first attack detection comprises calculating a Mahalanobis distance between the first sensor measurement and the second sensor measurement as the difference, and detecting a tentative attack when the difference exceeds a first threshold.

4. The method of claim 3,
wherein the performing of the second attack detection comprises predicting the environmental state using a second equation, and detecting a tentative attack when a difference exceeds a second threshold,
wherein the second equation is ŷₜ=f(yₜ−1, uₜ)+wₜ,
and wherein the wₜ is noise, and the f(·) is a predefined environmental state prediction function.

5. The method of claim 4,
wherein the performing of the third attack detection comprises calculating the probability using a third equation, and detecting the sensor spoofing attack when the probability is smaller than a third threshold,
wherein the third equation is
$$P ( {z}_{t} \vert {x}_{t} , {y}_{t} ) = 1 - {F}_{{χ}_{k}^{2}} ( {D}_{M}^{2} ) ,$$
and wherein the
$${F}_{{χ}_{k}^{2}}$$
is a cumulative distribution function of a Chi-squared distribution, and the D²_{M} is the difference calculated in the performing of the first attack detection.

6. The method of claim 5,
wherein the autonomous system is an autonomous vehicle, a drone, an autonomous robot, or an unmanned mobile vehicle, and the computing device is implemented as a part of the autonomous system,
and wherein the environmental state includes at least one of a 3D position of an object, a velocity of the object, dimensions of the object, a friction coefficient of a road, and a curvature of the road.
